(19) United States
(12) Patent Application Publication
(10) Pub. No.: US 2011/0202865 A1
(43) Pub. Date: Aug. 18, 2011

(54) PERSPECTIVE VIEW

(75) Inventors: Michael N. Tofinetti, Kanata (CA); Katha Kulasingam, Kanata (CA)

(73) Assignee: ALCATEL-LUCENT CANADA INC., Ottawa (CA)

(21) Appl. No.: 12/707,865

(22) Filed: Feb. 18, 2010

(51) Int. Cl. G06F 3/048

(52) U.S. Cl. 715/777; 715/781; 715/788; 715/843

(57) ABSTRACT

A method is provided for displaying a graphical user interface to a user. The graphical user interface includes a perspective, which is an arrangement of areas, each area containing at least one portlet which presents one aspect of stored information. The graphical user interface allows a user to easily switch between different perspectives, each perspective presenting a different layout of areas. Within each area, different portlets can be made visible using tabs to switch between the portlets. A new portlet can also be created within an area, as long as that type of portlet is allowed in that particular area. The invention allows a user to easily manage the view of many pieces of information without the clutter usually associated with many windows.

### FIELD OF THE INVENTION

This invention relates to graphical user interfaces, and more particularly to a method of displaying multiple pieces of information.

### BACKGROUND OF THE INVENTION

Management of customer information in telecommunication networks often requires the presentation of many pieces of information. For example, information related to billing rates and expected levels of service must be presented to an administrator so that the administrator can obtain current information or can edit information stored in a database. The information may be presented as lines of text, but a graphical user interface allows an administrator to select various items, to more easily view the current state of the selected items, and to more easily change the information related to the selected items.

The flexibility given to the administrator may come at a cost, however. As the administrator selects different views of the information, different aspects of the information presented to the administrator in different windows may become difficult to manage, especially when the administrator starts moving the windows around. For example, the administrator may wish to view information concerning a particular subscriber in a telecommunication network. A Listing window is used to find existing subscribers or to create new ones. Individual subscribers are created or edited in forms specific to the subscriber data. These forms contain many fields, such as category, user identifier, description, a list of subscription identifiers, custom data, and a list of called station identifiers. Each of these called station identifiers contains a large amount of information dealing with Quality of Service (QoS) parameters: defaults, aggregate maximum bit rates, guaranteed bit rates, maximum bit rates for QoS classes, associated AF applications, and custom data. Many of these are lists which open up configuration forms of their own. In addition, there is a separate search facility to find a subscriber by a specific subscription identifier. This is a search window which opens on top of the subscriber list.

A method of displaying information in an organized way which does not involve overlaying or overlapping of windows would avoid the clutter associated with multiple windows, and in particular make it easier for an administrator to manage customer information in a telecommunication network.

### SUMMARY OF THE INVENTION

According to one aspect, the invention provides a method of displaying a graphical user interface. A perspective is displayed. Within the perspective at least two areas are displayed. Within each area, at least one portlet tab is displayed, each portlet tab being associated with one portlet. Within each area, the portlet associated with a selected portlet tab is displayed.

More than one perspective may be available for viewing, in which case the perspective displayed is the one associated with a selected perspective tab.

The methods of the invention may be stored as processing instructions on computer-readable storage media, the instructions being executable by a computer processor.

The invention allows information to be presented to a user in a way which is easy for the user to manage. By using areas defined in a perspective, information is presented in an organized way to the user. The presentation of pieces of information using portlets within each area, the portlets within each area being selectable using tabs, allows the user to easily switch between pieces of information. The invention is useful for managing customer information for customers using a telecommunications network, such as customers using an Evolved Packet Core network, but may be useful for presenting other types of information to a user.

### BRIEF DESCRIPTION OF THE DRAWINGS

The features and advantages of the invention will become more apparent from the following detailed description of the preferred embodiment(s) with reference to the attached figures, wherein:

FIG. 1 is a diagram of an example perspective according to one embodiment of the invention;

FIG. 2 is a diagram of another example perspective according to one embodiment of the invention; and

FIG. 3 is a diagram of an example area according to one embodiment of the invention.

It is noted that in the attached figures, like features bear similar labels.

### DETAILED DESCRIPTION OF THE PREFERRED EMBODIMENTS

Broadly, a graphical user interface is displayed, the graphical user interface having one perspective, which has at least two areas, each of which has at least one portlet. These levels of the display are described below with reference to the figures.

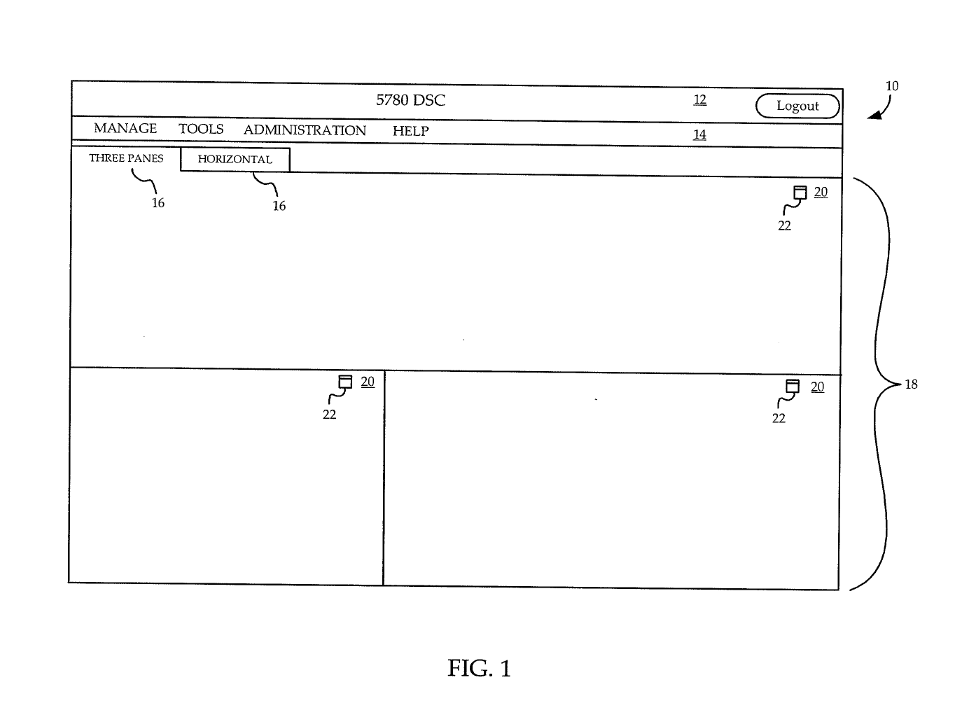

Referring to FIG. 1, a diagram of an example perspective according to one embodiment of the invention is shown. At the top level a user is presented with an application interface 10. Preferably, the application interface 10 occupies the entire display area of a display device. The application interface 10 includes a title bar 12, a menu bar 14, one or more tabs 16 called “perspective tabs”, and one or more stacked views called “perspectives” 18. Each perspective tab 16 has an associated perspective 18, and selecting one of the perspective tabs makes the perspective 18 associated with that perspective tab visible. Each perspective is an overall view of some aspect of information. Only one perspective is displayed, but if more than one perspective is available then the user can select a particular perspective to be displayed using the perspective tabs. In the example shown in FIG. 1, the user can select between two perspectives. The available perspectives may be either predefined or may be generated by the user. Generation of a perspective by a user provides flexibility in what data the user sees or interacts with.

Each perspective contains at least two panes, termed “areas”. In the example shown in FIG. 1, the perspective 18 contains three areas 20. Within a displayed perspective 18, the areas 20 may be resized but in general may not be created or destroyed. In other words, the number of areas within each perspective is normally fixed, but more generally a user may create one or more areas within a perspective. The definition of each area includes the types of portlet (described below) permitted in the area, in other words the types of portlet that can exist or be created within the area. Each area also has a maximize icon 22 for maximizing the area to occupy the entire perspective view, at which point a normalize icon (not shown in FIG. 1) becomes visible or selectable for restoring the area to its normal size.

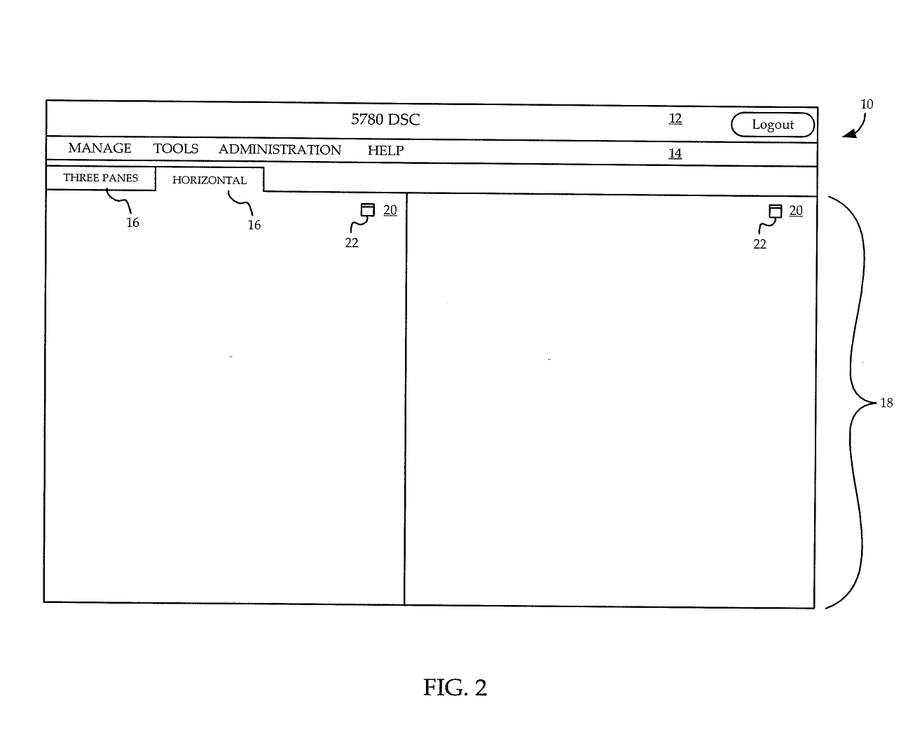

A diagram of another example perspective according to one embodiment of the invention is shown in FIG. 2. In the example shown in FIG. 2, the second perspective tab 16 has been selected, and the visible perspective associated with the second tab has only two areas.

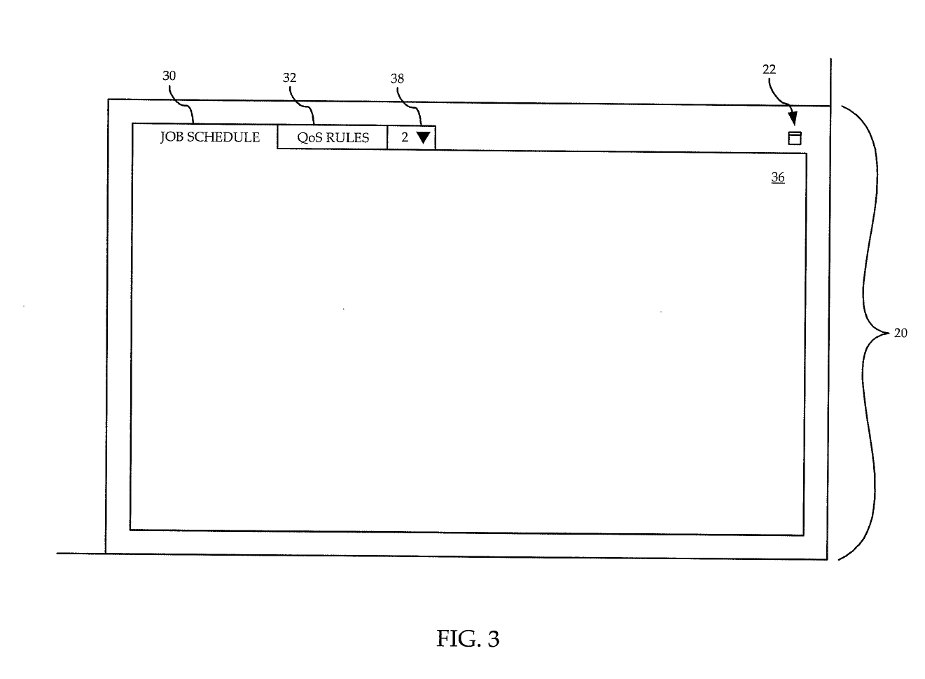

Referring to FIG. 3, a diagram of an example area 20 according to one embodiment of the invention is shown. The area includes at least one tab 30 and 32 called a “portlet tab”, and at least one stacked panel called a “portlet” 36. If a portlet tab is not visible due to width constraints of the area in which the portlet tab would otherwise be present, then a drop-down list 38 containing identifications of additional portlets is used. Each portlet tab and if present each item in the drop-down list has an associated portlet, and selecting one of the portlet tabs or an item in the drop-down list makes the portlet 36 associated with that portlet tab or item visible. Each portlet is a display of a particular piece of the information. Only one portlet is displayed within each area, but if more than one portlet is available then the user can select a particular portlet to be displayed using the portlet tabs or drop-down list within the area. In the example shown in FIG. 3, the user can select between four portlets in the area, although selection of a portlet for viewing in an area does not affect which portlets are selectable or visible in other areas.

Each portlet presents information of a type specific to that portlet. A portlet can be a list of information or a form presenting current information and allowing the current information to be changed. Portlets can be destroyed in an area and can be added to an area. A portlet can also be moved between areas by clicking and dragging the portlet to a destination area, as long as the type of portlet is allowed in the destination area.

The logic of the methods is preferably in the form of software, and may be stored as instructions on computer-readable storage media which can cause a computer processor to display the graphical user interface on a display device. The information presented in the portlets may be information about customers in a telecommunication network, which may be obtained from a database, or may be any other sort of information.

The embodiments presented are exemplary only and persons skilled in the art would appreciate that variations to the embodiments described above may be made without departing from the spirit of the invention. For example, the various menus, title bars, and icons described above and shown in the figures are examples only, and other text and/or icons can be used. The scope of the invention is solely defined by the appended claims.

I/we claim:

1. A method of displaying a graphical user interface, comprising:
displaying one perspective;
within the perspective, displaying at least two areas;
within each area, displaying at least one portlet tab, each portlet tab being associated with one portlet; and
within each area, displaying the portlet associated with a selected one of the at least one portlet tab within the area.

2. The method of claim 1 further comprising displaying at least two perspective tabs, each of which has an associated perspective, and wherein the perspective which is displayed is associated with a selected one of the at least two perspective tabs.

3. The method of claim 1 further comprising displaying an application interface which includes the displayed perspective, and wherein the application interface occupies the entire display area of a display device.

4. The method of claim 3 wherein each area includes means for maximizing the area so that the area occupies the entire displayed perspective.

5. The method of claim 1 wherein at least one type of portlet permissible within each area is defined for the area.

6. The method of claim 5 further comprising means for moving a selected portlet from a first of the areas to a second of the areas if the selected portlet is of a type permitted in the second area.

7. The method of claim 1 further comprising displaying within each area means for creating a new portlet within the area.

8. The method of claim 1 further comprising displaying a drop-down list in at least one of the areas, each drop-down list containing an identification of at least one portlet, and wherein the portlet displayed in an area is associated with either a selected portlet tab or a selected identification within the drop-down list.
